(19) United States
(12) Patent Application Publication
(10) Pub. No.: US 2010/0331472 A1
(43) Pub. Date: Dec. 30, 2010

(54) METAL FILLED POLYURETHANE COMPOSITION AND MOULDS PREPARED THEREFROM

(75) Inventor: Elisa Corinti, Correggio (IT)

Correspondence Address: The Dow Chemical Company, P.O. BOX 1967, 2040 Dow Center, Midland, MI, 48641, US

(73) Assignee: Dow Global Technologies Inc., Midland, MI (US)

(21) Appl. No.: 12/516,893

(22) PCT Filed: Nov. 26, 2007
(86) PCT No.: PCT/EP2007/062835

§ 371 Date: Sep. 15, 2010

(30) Foreign Application Priority Data
Dec. 1, 2006 (EP) 06256166.7

(51) Int. Cl. C08K 3/08

(52) U.S. Cl. 524/440; 524/439; 524/441

(57) ABSTRACT

A composition comprising a polyurethane and from 20 to 80 weight percent of a particulate metal or metal alloy filler, wherein polyurethane is the reaction product of a first polyol having a molecular weight of less than 1000, a second polyol having a molecular weight of from 1500 to 10000, and at least one polyisocyanate, and wherein the particulate metal or metal alloy filler has a thermal conductivity of at least 150 watts/m·° K, a mould made therefrom and a method of producing such a mould.

The present invention relates to a polyurethane composition, a method of making the polyurethane composition and the use of the polyurethane composition for making moulds, particularly moulds for shoe soles.

Moulds for shoe soles are typically made of aluminium. The problem with these moulds are that they are expensive, because aluminium is an expensive raw material, and the cost associated with a slow production time as a result of the difficulty of working with aluminium blocks.

It is known to use other materials when producing moulds for shoe soles, such as polyurethane, as disclosed in EP1323755. However, moulds made from these materials also suffer from considerable disadvantages. Although initial shoe sole production is good, there is a rapid increase in mould temperature from 25 to 60° C., with soles moulded at a temperature of greater than 45° C. showing problems caused by a change in the chemical reactivity of the surface of the polyurethane mould at temperatures greater than 45° C. This problem could be resolved by cooling the moulds or allowing them to be cooled to less than 40° C. However, this has the disadvantage of slowing down the process.

U.S. Pat. No. 6,602,936 discloses a composition comprising a resin containing a single polyepoxide and a polyisocyanate and a filler, which can be a metal powder.

Accordingly, it is the aim of the present invention to provide a new material which can be used for making moulds, particularly for shoe soles, the material being cheaper than the aluminium moulds currently used. In addition, it is the aim of the present invention that the material can be processed using the same tools as for aluminium moulds, but more easily and more quickly, but at the same time can produce soles of equivalent quality and at an equivalent rate to aluminium moulds.

In a first aspect of the present invention, there is provided a composition comprising a polyurethane and from 20 to 80 weight percent of a particulate metal or metal alloy filler, wherein polyurethane is the reaction product of:

a) a first polyol, the first polyol having a molecular weight of less than 1000;
b) a second polyol, the second polyol having a molecular weight of from 1500 to 10000; and
c) at least one polyisocyanate, and
wherein the particulate metal or metal alloy filler has a thermal conductivity of at least 150 watts/m·° K. The metal or metal alloy can be non-ferromagnetic or ferromagnetic. In one preferred embodiment, the metal or metal alloy is non-ferromagnetic, and more preferably at least one of aluminium, copper, zinc, gold, bronze and silver. Preferably, the particulate is in the form of one or more of granules, platelets, pellets, beads, flakes, particles, lamellae or grains. Preferably, at least one of the first and second polyols is a polyether polyol, and more preferably, both first and second polyols are polyether polyols.

The composition preferably additionally comprises at least one of a water absorbent, such as a zeolite; an antifoaming agent; and a viscosity cutter. Some antifoaming agents can act as a viscosity cutter, and so an additional viscosity cutter may not be required.

A particularly preferred composition comprises a polyurethane, a zeolite paste and a particulate metal or metal alloy filler, wherein the polyurethane is the reaction product of:

a) from 40 to 60 parts by weight of a first polyether polyol, the first polyether polyol having a molecular weight of from 100 to 600 and a functionality of from 2 to 8;
b) from 40 to 60 parts by weight of a second polyether polyol, the second polyether polyol having a molecular weight of from 1500 to 8000 and a functionality of from 2 to 6; and
c) at least one isocyanate, wherein the isocyanate is present in an amount to provide for an isocyanate index of from 80 to 115, and
wherein the composition comprises
from 5 to 15 parts by weight of the zeolite paste and from 50 to 200 parts by weight of a particulate aluminium filler.

The composition of the first aspect of the invention may be used to produce any solid article. However, it is particularly suitable for producing a mould, such as a mould for forming part of a footwear article, such as a shoe or a boot, and in particular for forming a sole of the footwear article. The composition can also be used in the production of moulds for other purposes, such as for producing furniture parts and mechanical parts.

The mould is suitable for use where the article to be produced is a plastics material, such as polyurethane, and in particular for the production of an article in which the plastics material can be poured or injected into the mould. Typical conditions for pouring the plastics material are a temperature range of from 25 to 130° C. and a pressure of 0 to 5 bar. However, the moulds are also suitable for use at temperatures higher than 130° C.

Polyurethane foams are commonly used to manufacture a large number of different articles. One particular example is the field of sporting goods, and more particularly, shooting and archery targets, which may be in the form of animals and birds. The moulds used in the production of these targets are usually very crude, and as they are typically sold very cheaply, it is not economical to use custom-made metal moulds to produce higher quality, less crude targets. The compositions of the present invention are particularly suitable for use in the production of moulds, for example by using computer-aided design, which can produce targets having greater detail. The moulds produced are both cheap and of high quality, which will reduce the number of rejects produced.

The composition is particularly suited for the production of moulds for prototype articles. The nature of the composition is such that it can be produced easily and cheaply, and can readily be formed into the shape of a mould.

In a second aspect of the present invention, there is provided a mould for producing a plastics material part comprising a polyurethane and a particulate metal or metal alloy filler, wherein the polyurethane is the reaction product of:

a) a first polyol, the first polyol having a molecular weight of less than 1000;
b) a second polyol, the second polyol having a molecular weight of from 1500 to 10000; and
c) at least one polyisocyanate. Preferably, at least one of the first and second polyols is a polyether polyol, and more preferably, both first and second polyols are polyether polyols.

In a third aspect of the present invention, there is provided a mould for a part of a footwear article, for example a sole, formed from a composition comprising a polyurethane and at least one particular metal or metal alloy filler, wherein the polyurethane is the reaction product of at least one polyol and at least one isocyanate. Preferably, the polyol is a polyether polyol.

Without wishing to be bound by theory, it is thought that one of the major problems with polyurethane-only moulds is poor heat dissipation. By inclusion of one or more specific particulate metals or metal alloys as a filler in the polyurethane formation, it is possible to provide to improve the heat dissipation of the material.

A large number of alternative materials could be used which have improved heat dissipation, including metal carbonates, oxides, sulphates and sulphides. However, it is not sufficient simply to improve heat dissipation; it is also necessary to ensure that the composition has the correct properties for machining into the shape of the mould, including turning, milling, shaving, holing and threading. It is important that the material does not produce excessive dust when being machined. In addition, it is important that the material is sufficiently structurally sound to ensure that a mould can be made. It is also important that the material does not have excessive thermal expansion, which would affect the shape of the mould as it gets hotter during use. Further important features are that the composition is not too dense, and has sufficient hardness.

In a fourth aspect of the present invention, there is provided a method of producing a mould, comprising the steps of:

i) mixing a first polyol having a molecular weight of less than 1000 and a second polyol having a molecular weight of from 1500 to 10000;
ii) adding a particulate metal filler to the mixture of step i) wherein the metal has a thermal conductivity of at least 150 watts/m·° K;
iii) mixing the polyol and filler mixture under vacuum; and
iv) adding at least one isocyanate and mixing. Optionally, step iv) can be undertaken under vacuum. However, it is typically undertaken at ambient pressure. Preferably, at least one of the first and second polyols is a polyether polyol, and more preferably, both first and second polyols are polyether polyols.

In a preferred embodiment, a water absorbent, such as a zeolite, is additionally added in step i).

It is preferable that the surface of the mould is sufficiently smooth so that there are no defects on the surface of the resultant sole. When the filler and the polyol are mixed, bubbles form in the mixture which results in flaws in the mould material which are then present on the surface of the mould after machining. Mixing the components under vacuum, and in particular the mixing of the polyol side of the reactants, including addition of the filler, prevents or reduces air bubble formation. Addition of an anti-foaming agent is also useful for preventing or reducing bubble formation. Where the polyol and filler are mixed under vacuum, the resultant composition has a very smooth, shiny finish. However, when the composition is formed without the use of vacuum, the surface finish tends to be matte, and have imperfections due to air bubbles on the surface of the composition.

The mould can be formed by any known methods. Suitable methods include pouring the reaction mixture onto a model to form the mould or milling a block to the appropriate mould shape.

The composition of the present invention is particular useful for the production of moulds for prototype parts, where a relatively small quantity of parts (for example up to 1000) are required. A mould according to the present invention can be produced more quickly and more cost effectively than the corresponding aluminium mould. This enables the producer to produce a set of identical parts for rapid evaluation, without the high cost of producing an aluminium mould, as was previously necessary. However, the composition is also suitable for use in the production of moulds for other plastics material parts as well as prototypes.

Accordingly, in a fifth aspect of the present invention, there is provided a method of producing a plastics material part, comprising producing the mould as described above or undertaking the method as described above, and using the mould to produce the part. Preferably, the part is a prototype part.

It is preferred that the composition of the present invention is non-cellular, that is the composition is not a foam. In one preferred embodiment, the composition has a density of at least 1.2 g/cm³. More preferably, the composition has a density of at least 1.3 and yet more preferably 1.45 g/cm³. Preferably, the composition has a density of less than 2.2 g/cm³, more preferably less than 1.8 g/cm³.

It is preferred that the only polymer present is a polyurethane in the composition. It is particularly preferred that the composition does not contain any polyepoxide.

A number of different metal or metal alloy particulates are suitable for use as the filler in the present invention. The metal or metal alloy particulate to be used can either be one metal or metal alloy or a mixture of metals and/or metal alloys. The metal or metal alloy to be used is typically one having a high thermal conductivity. Suitable metals are ones having a thermal conductivity of at least 150 watts/m·° K. It is preferred that the metal has a thermal conductivity of at least 180, more preferably at least 200 watts/m·° K. The metal or metal alloy is suitably one which is not ferro-magnetic. However, in some cases, ferromagnetic metals can be used on their own or in combination with non-ferromagnetic metals. Suitable metals or metal alloys include aluminium (235 watts/m·° K), copper (400 watts/m·° K), zinc (194 watts/m·° K), bronze, gold (317 watts/m·° K) and silver (429 watts/m·° K). It is preferred that the metal is aluminium or copper or a combination thereof, and more preferably the metal is aluminium.

The metal filler is in the form of a particulate such that it can be spread throughout the resultant polyurethane composition during mixing of the polyol side, prior to addition of the isocyanate. Exemplary types of particulate include granules, platelets, pellets, beads, flakes, particles or grains. However, the present invention can suitably be used with any type of particulate. It is particularly suitable that the metal or metal alloy filler is in the form of spherical or substantially spherical particulate. Fillers of this type offer the best all round characteristics. Where fillers which are platelets are used, the thermal conductivity of the resultant polymer is substantially improved. However, the reaction mixture is very viscous and hard to mix, and therefore platelets are less favourable than spherical particulate. Preferably the particulate has a mean diameter of from 20 to 100 micrometers, regardless of shape. It is particularly preferred that the filler consists of metal or metal alloy particles having a mean diameter of from 20 to 40 micrometers. Particularly preferred are aluminium particles having a mean diameter of from 30 to 40 micrometers.

The metal or metal alloy filler is preferably used in an amount of from 20 to 80 weight percent, based on the total weight of the composition. It is further preferred that the metal filler is used in an amount of from 30 to 70 weight percent, and yet more preferably from 35 to 55 weight percent.

The compositions of the present invention are formed using a polyurethane, which is the reaction product of at least one polyol and at least one isocyanate. Although it is preferred that the polyol is a polyether polyol, a polyester polyol can be used.

Suitably, the composition is formed using a first polyol having a molecular weight of less than 1000 (a low molecular weight polyol) and a second polyol having a molecular weight of from 1500 to 10000 (a high molecular weight polyol). The combination of two different polyols provides a polyurethane having excellent physical properties for use as a mould. The low molecular weight polyol provides the hardness for the resultant composition, whilst the high molecular weight composition provides elasticity to prevent the composition being too brittle.

It is preferred that at least one of the first and second polyols are polyether polyols, and more preferably, both first and second polyols are polyether polyols.

The low molecular weight polyether polyol preferably has a molecular weight of from 100 to 600 g/mol, more preferably from 125 to 500 and most preferably from 150 to 450 g/mol.

The low molecular weight polyether polyols include those obtained by the alkoxylation of suitable starting molecules with an alkylene oxide, such as ethylene, propylene, butylene oxide, or a mixture thereof. Examples of initiator molecules include water, ammonia, aniline or polyhydric alcohols such as dihydric alcohols, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glycol or tripropylene glycol. Other commonly used initiators include pentaerythritol, xylitol, arabitol, sorbitol, mannitol and the like. Particularly preferred is glycerin.

Preferably a poly(propylene oxide) polyol, including poly(oxypropylene-oxyethylene) polyols, is used. Preferably the oxyethylene content should comprise less than about 40 weight percent of the total and preferably less than about 25 weight percent of the total weight of the polyol. The ethylene oxide can be incorporated in any manner along the polymer chain, which stated another way means that the ethylene oxide can be incorporated either in internal blocks, as terminal blocks, may be randomly distributed along the polymer chain, or may be randomly distributed in a terminal oxyethylene-oxypropylene block. These polyols are conventional materials prepared by conventional methods.

Other polyether polyols include the poly(tetramethylene oxide) polyols, also known as poly(oxytetramethylene) glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

The low molecular weight polyol preferably has a functionality, i.e the number of isocyanate reactive hydrogens per polyol, of at least 1.5, more preferably from 2 to 8, yet more preferably from 2 to 6 and most preferably from 2 to 4.

The polyol preferably has a hydroxyl number of from 100 to 700 and preferably from 400 to 600.

A particularly preferred low molecular weight polyether polyol is Voranol® CP 260, which is available from The Dow Chemical Company. This polyol has a functionality of 3 and a molecular weight of 260 g/mol.

The amount of low molecular weight polyol used is preferably from 5 to 95 weight percent, based on the total amount of polyol used. More preferably, from 10 to 90, yet more preferably from 15 to 85 and most preferably from 40 to 60 weight percent of low molecular weight polyol is used.

The high molecular weight polyether polyols include those obtained by the alkoxylation of suitable starting molecules with an alkylene oxide, such as ethylene, propylene, butylene oxide, or a mixture thereof. Examples of initiator molecules include water, ammonia, aniline or polyhydric alcohols such as dihydric alcohols having a molecular weight of 62 to 399, especially the alkane polyols such as ethylene glycol, propylene glycol, hexamethylene diol, glycerol, trimethylol propane or trimethylol ethane, or the low molecular weight alcohols containing ether groups such as diethylene glycol, triethylene glycol, dipropylene glycol or tripropylene glycol. Other commonly used initiators include pentaerythritol, xylitol, arabitol, sorbitol, mannitol and the like. Particularly preferred is glycerin.

Preferably a poly(propylene oxide) polyol, including poly(oxypropylene-oxyethylene) polyols, is used. Preferably the oxyethylene content should comprise less than about 40 weight percent of the total and preferably less than about 25 weight percent of the total weight of the polyol. The ethylene oxide can be incorporated in any manner along the polymer chain, which stated another way means that the ethylene oxide can be incorporated either in internal blocks, as terminal blocks, may be randomly distributed along the polymer chain, or may be randomly distributed in a terminal oxyethylene-oxypropylene block. These polyols are conventional materials prepared by conventional methods.

Other polyether polyols include the poly(tetramethylene oxide) polyols, also known as poly(oxytetramethylene) glycol, that are commercially available as diols. These polyols are prepared from the cationic ring-opening of tetrahydrofuran and termination with water as described in Dreyfuss, P. and M. P. Dreyfuss, Adv. Chem. Series, 91, 335 (1969).

The high molecular weight polyol preferably has a molecular weight of from 1500 to 8000, more preferably from 2000 to 7000, yet more preferably from 2500 to 6000 and most preferably from 4000 to 5000 g/mol. The high molecular weight polyol preferably has a functionality of at least 1.5, more preferably from 2 to 6, yet more preferably from 2 to 4 and most preferably from 2 to 3. A particularly preferred polyol is a mixed propylene oxide-ethylene oxide polyol, with an ethylene oxide endcap. The polyol preferably has a hydroxyl number of from 20 to 90 and more preferably from 30 to 40. A particularly preferred high molecular weight polyether polyol is Voranol® CP 4711, which is available from The Dow Chemical Company. This polyol is formed using a glycerin starter and is a mixed ethylene oxide-propylene oxide polyol having a 14% ethylene oxide endcap. The polyol has a molecular weight of 4700, an OH value of 35 and a primary OH content of 70 to 75%.

The amount of high molecular weight polyol used is preferably from 5 to 95 weight percent, based on the total amount of polyol used. More preferably, from 10 to 90, yet more preferably from 15 to 85, even more preferably from 30 to 70 and most preferably from 40 to 60 weight percent of high molecular weight polyol is used.

Suitable polyester polyols which can be used instead of one or both of the polyether polyols include those produced from dicarboxylic acids, preferably aliphatic dicarboxylic acids, having 2 to 12 carbon atoms in the alkylene radical, and multifunctional alcohols, preferably diols. These acids include, for instance, aliphatic dicarboxylic acids such as glutaric acid, pimelic acid, suberic acid, azelaic acid, sebacic acid, undecanedioic acid, dodecanedioic acid, and preferably, succinic and adipic acids; cycloaliphatic dicarboxylic acids such as 1,3- and 1,4-cyclohexane dicarboxylic acid; and aromatic dicarboxylic acids such as phthalic acid and terephthalic acid. Examples of di- and multifunctional, particularly difunctional, alcohols are: ethylene glycol, diethylene glycol, propylene glycol, dipropylene glycol, 1,3-propanediol, 1,10-decanediol, glycerine, trimethylolpropane, and preferably, 1,4-butanediol, and 1,6-hexanediol. Other suitable polyester polyols would be known to the skilled person.

Other polyols can also be used in combination with the low and high molecular weight polyols. Such polyols are preferably used in an amount of less than 10 weight percent of the total polyol used. However, it is preferred that no other polyols are used.

Suitable polyisocyanates for use in the present invention include aliphatic, cycloaliphatic, araliphatic and preferably aromatic polyfunctional isocyanates.

Specific examples are: alkylene diisocyanates having from 4 to 12 carbon atoms in the alkylene radical, for example dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate; cycloaliphatic diisocyanates such as cyclohexane 1,3- and 1,4-diisocyanate and also any mixtures of these isomers, 1-isocyanato-3,3,5-trimethyl-5-isocyanatomethylcyclohexane (isophorone diisocyanate), hexahydrotolylene 2,4- and 2,6-diisocyanate and also the corresponding isomer mixtures, dicyclohexylmethane 4,4′-, 2,2′- and 2,4′-diisocyanate and also the corresponding isomer mixtures, and preferably aromatic diisocyanates and polyisocyanates, such as tolylene 2,4- and 2,6-diisocyanate and the corresponding isomer mixtures, diphenylmethane 4,4′-, 2,4′- and 2,2′-diisocyanate and the corresponding isomer mixtures, mixtures of diphenylmethane 4,4′- and 2,4′-diisocyanates, polyphenylpolymethylene polyisocyanates, mixtures of diphenylmethane 4,4′-, 2,4′- and 2,2′-diisocyanates and polyphenylpolymethylene polyisocyanates (raw MDI) and mixtures of raw MDI and tolylene diisocyanates. The organic diisocyanates and polyisocyanates can be used individually or in the form of their mixtures.

Other suitable isocyanates are modified polyfunctional isocyanates, i.e. products which are obtained by chemical reaction of organic diisocyanates and/or polyisocyanates. Examples which may be mentioned are diisocyanates and/or polyisocyanates containing ester, urea, biuret, allophanate, carbodiimide, isocyanurate, uretdione and/or urethane groups. Specific examples are: organic, preferably aromatic polyisocyanates containing urethane groups and having NCO contents of from 33.6 to 15% by weight, preferably from 31 to 21% by weight, based on the total weight, for example diphenylmethane 4,4′-diisocyanate modified with low molecular weight diols, triols, dialkylene glycols, trialkylene glycols or polyoxyalkylene glycols having molecular weights up to 6000, in particular having molecular weights up to 1500, modified diphenylmethane 4,4′- and 2,4′-diisocyanate mixtures or modified raw MDI or tolylene 2,4- or 2,6-diisocyanate, with examples of dialkylene glycols or polyoxyalkylene glycols which can be used individually or as mixtures being: diethylene glycol, dipropylene glycol, polyoxyethylene, polyoxypropylene and polyoxypropylene-polyoxyethylene glycols, triols and/or tetrols. Also suitable are prepolymers containing NCO groups and having NCO contents of from 25 to 3.5% by weight, preferably from 21 to 14% by weight, based on the total weight, and prepared from the polyester and/or preferably polyether polyols described below and diphenylmethane 4,4′-diisocyanate, mixtures of diphenylmethane 2,4′- and 4,4′-diisocyanate, tolylene 2,4- and/or 2,6-diisocyanates or raw MDI. Other modified polyisocyanates which have been found to be useful are liquid polyisocyanates containing carbodiimide groups and/or isocyanurate rings and having NCO contents of from 33.6 to 15% by weight, preferably from 31 to 21% by weight, based on the total weight, for example those on the basis of diphenylmethane 4,4′-, 2,4′- and/or 2,2′-diisocyanates and/or tolylene 2,4- and/or 2,6-diisocyanate.

The modified polyisocyanates can, if desired, be mixed with one another or with unmodified organic polyisocyanates such as diphenylmethane 2,4′- and/or 4,41-diisocyanate, raw MDI, tolylene 2,4- and/or 2,6-diisocyanate.

Polyisocyanates which have been found to be particularly useful are diphenylmethane diisocyanate isomer mixtures or raw MDI having a diphenylmethane diisocyanate isomer content of from 33 to 55% by mass and polyisocyanate mixtures containing urethane groups and based on diphenylmethane diisocyanate having an NCO content of from 15 to 33% by mass.

A preferred isocyanate is ISONATE® M143, which is commercially available from The Dow Chemical Company. ISONATE® M143 has an NCO content of 29.5 weight percent, an equivalent weight of 1.43 and a functionality of 2.15.

When preparing a polyurethane polymer according to this invention, the polyisocyanate is used in an amount to provide for an isocyanate reaction index of advantageously from 80 to 130, preferably from 85 to 110, and more preferably from 90 to 105. By the term “isocyanate index” it is understood that at an index of 100, one equivalent of isocyanate is present for each isocyanate reactive hydrogen atom present from the polyol, or other active hydrogen atom bearing substance able to react with the polyisocyanate.

Additional optional components which are suitably included in the composition include additional filler, surface active agents, water absorbents, anti-foaming agents, viscosity cutters and colorants. These components are typically added to the polyol side of the reactants, prior to addition of the polyisocyanate.

Additional fillers can be any standard filler known to the skilled person, such as for example chalk or mica. Additional fillers, where present, are used in amounts of less that 10% and preferably less than 5% by weight, based on the total weight of the composition.

Suitable surface-active substances are, for example, compounds which serve to aid the homogenization of the starting materials and may also be suitable for regulating the cell structure of the plastics. Examples which may be mentioned are emulsifiers such as the sodium salts of castor oil sulphates or of fatty acids and also amine salts of fatty acids, e.g. diethylamine oleate, diethanolamine stearate, diethanolamine ricinoleate, salts of sulfonic acids, e.g. alkali metal or ammonium salts of dodecylbenzene- or dinaphthylmethanedisulfonic acid and ricinoleic acid; foam stabilizers such as siloxane-oxalkylene copolymers and other organopolysiloxanes, ethoxylated alkylphenols, ethoxylated fatty alcohols, paraffin oils, castor oil or ricinoleate esters, Turkey red oil and peanut oil and cell regulators such as paraffins, fatty alcohols and dimethylpolysiloxanes. The above-described oligomeric acrylates having polyoxyalkylene and fluoroalkane radicals as side groups are also suitable for improving the emulsifying action, the cell structure and/or stabilizing the foam. The surface-active substances are usually employed in amounts of from 0.01 to 5 parts by weight, based on 100 parts by weight of polyol.

Any suitable water absorbents known to the skilled person can be used. However, it is preferred that the water absorbent is a zeolite. The zeolite can be added in powder form or in paste form. A particularly preferred zeolite paste is Voratron EG 711, produced by the Dow Chemical Company.

Any suitable anti-foaming agents known to the skilled person can be used, including silicone and non-silicone containing anti-foaming agents. It is preferred that the anti-foaming agent is used in an amount of less than 2 percent by weight. One preferred commercially available anti-foaming agent is Antifoam 1500, which is produced by Dow Corning.

It is also preferred that the composition includes a viscosity cutter. In some cases, the anti-foaming agent acts as the viscosity cutter. However, where a separate viscosity cutter is used, it is typically used in an amount of less than 2 percent by weight. The skilled person would understand which suitable viscosity cutters could be used. Some commercially available viscosity cutters include those of BYK-Chemie, such as BYK®-W 985, BYK®-W 995 and BYK®-W 996.

Preferred embodiments of the invention will be described with reference to the drawings in which:—

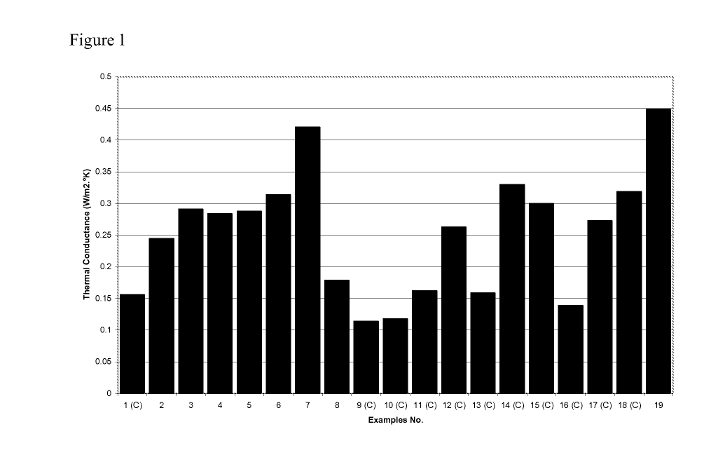

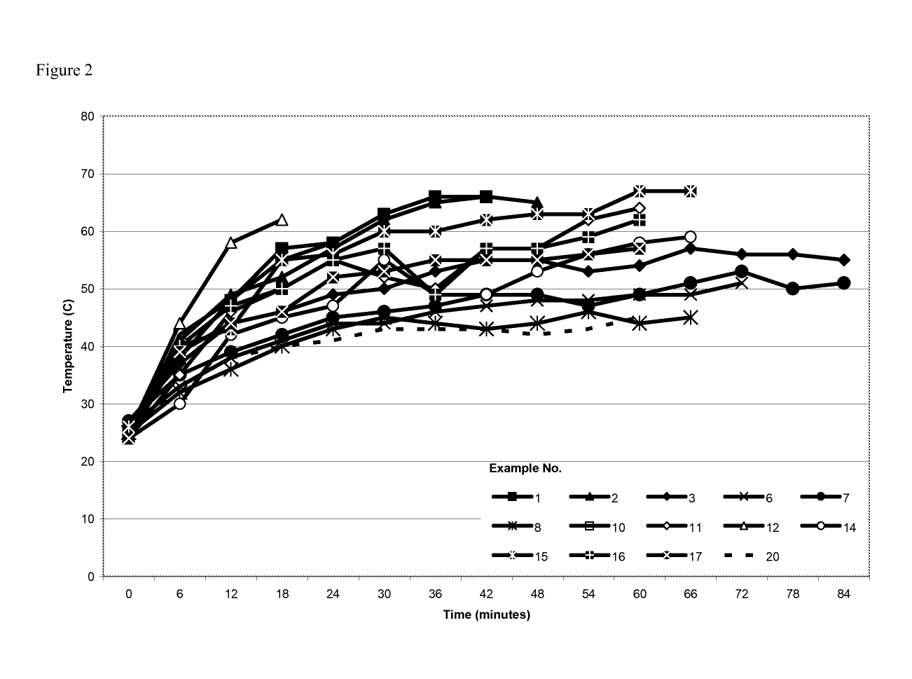

FIG. 1 is a bar chart showing the thermal conductivity of a series of polymers containing a filler;
FIG. 2 is a chart showing the surface temperature of a series of bone moulds during moulding.

### EXAMPLES 1 TO 10

A number of different compositions were made using a variety of different fillers, as well as a polyurethane-only composition. All of the compositions were made using the same basic polyurethane composition as shown in Table 1:

TABLE 1

| | Amount (by |
|---|---|
| Component | weight) |
| High molecular weight polyol (Voranol CP 4711) | 46.19 |
| Catalyst (Triethylene diamine 33% in dipropylene glycol) | 0.05 |
| Zeolite paste (Voratron EG 711) | 7.39 |
| Low molecular weight polyol (Voranal CP 260) | 46.19 |

The isocyanate (Isonate 143M) was added to give an isocyanate index of between 90 and 95.

Filler, where added, was added to a mixture of the polyols, zeolite paste and catalyst, and was stirred thoroughly. The isocyanate and the polyol containing mixture are then mixed together.

In Examples 1 to 20, the polyurethane mixture for each example was formed into a plate of dimension 20 cm×20 cm by 1 cm and the thermal conductance of the plate was measured using a LASERCOMP FOX 200 using EN 12667. The thermal conductance was measured in the temperature range of 30 to 40° C. The weight percentage for each filler used, based on the total weight of the composition, and the resulting thermal conductance of the composition are given in Table 2. The thermal conductance results are shown in FIG. 1.

TABLE 2

| | | WT % | THERMAL CONDUCTANCE |
|---|---|---|---|
| EXAMPLE | FILLER | FILLER | (W/m² · ° K) |
| 1 (C) | No Filler | — | 0.156 |
| 2 | 30 micrometers Al powder | 35% | 0.245 |
| 3 | 30 micrometers Al powder | 50% | 0.291 |
| 4 | 100 micrometers Al powder | 50% | 0.284 |
| 5 | 100 micrometers Al powder | 60% | 0.288 |
| 6 | 30 micrometers Al powder | 75% | 0.314 |
| 7 | 30 micrometers lamellar Al | 30% | 0.421 |
| 8 | 30 micrometers Cu powder | 35% | 0.179 |
| 9 (C) | 50 micrometers BaSO₄ powder | 35% | 0.114 |
| 10 (C) | 50 micrometers BaSO₄ powder | 50% | 0.118 |
| 11 (C) | 50 micrometers CaCO₃ powder | 35% | 0.162 |
| 12 (C) | 50 micrometers dolomite (CaMg(CO₃)₂) powder | 50% | 0.263 |
| 13 (C) | 50 micrometers FeS powder | 50% | 0.159 |
| 14 (C) | 50 micrometers silica (SiO₂) powder | 50% | 0.33 |
| 15 (C) | 25 micrometers pyrite (FeO2) powder | 50% | 0.3 |
| 16 (C) | 175 micrometers pyrite (FeO2) powder | 50% | 0.139 |
| 17 (C) | 3 micrometers pyrite (FeO2) powder | 50% | 0.273 |
| 18 (C) | 50 micrometers alumina (Al₂O₃) powder | 50% | 0.319 |
| 19 | 30 micrometer Al powder and lamellar Al | 30% powder, | 0.449 |
| | | 20% lamellar | |

Examples marked (C) are comparative examples and are not part of the present invention. They relate to compositions made with the same polyurethane, but with no filler or non-metallic fillers.

It can be seen that the composition comprising the mixture of Al powder and lamellar Al has a particularly high thermal conductance, which is higher than the powder or lamellar Al alone. The use of a mixture of particulate of different shapes appears to provide a synergistic effect. Accordingly, in a preferred embodiment, the metal particulate is formed of a mixture of substantial spherical particulate and lamellar particulate

Polyurethane moulds were formed using the compositions in Table 2 for making so called “bone” moulds, which are moulds for forming flat sheets. The bone mould was formed to measure the temperature behaviour of the mould during pouring of a polyurethane formulation that is typically used for making shoe moulds. FIG. 2 shows the temperature measurement of the surface of the moulds after pouring of the polyurethane into the mould.

The same compositions were also formed into blocks so that the physical properties could be measured, including the suitability of the materials for processing into moulds by turning, milling, holing and threading.

As well as the measurement of the thermal conductance of the composition, it is also important that the composition does not show significant thermal expansion. The thermal expansion was measured by measuring the change in the length of the part relative to the initial length of the part over a temperature range. The shrinkage is given per degree of temperature change. Other physical properties are also important, such as the density and the hardness. A mould should have a density of less than 1.8 g/cm³ and a hardness of greater than 70 when measured by Shore D, according to ASTM D2240.

In addition, the properties on machining are important. The composition must be sufficiently dimensionally stable such that it does not break or collapse on machining, that it has a good surface quality and that the composition does not form excessive dust on milling. The production of dust is not only dangerous for the workers, but also causes problems for cleaning of the apparatus after milling. By consideration of these features, it is possible to assess both qualitatively and quantitatively whether a particular formulation is suitable for use as a mould.

Table 3 below compares the results of these tests for a number of the Examples. As can be seen, the compositions of the present invention compare favourably with those which are not part of the present invention. In particular, the compositions which are not part of the invention typically demonstrate either poor thermal conductance or poor expansion, as well as often producing dust on milling.

TABLE 3

| | | | Thermal property | | Machining quality | | |
|---|---|---|---|---|---|---|---|
| | Physical property | | Thermal | Thermal | | Finishing | |
| | Density | Hardness | expansion | Conductance | Absence | surface of | |
| Example | <1.8 g/cm³ | >70 Shore D | <70(10⁻⁶/° C.) | >0.2 (W/m/K) | of Dust | sufficient quality | Total |
| 1 (C) | X | X | X | | X | X | 5 |
| 2 | X | X | X | X | X | | 5 |
| 3 | X | X | X | X | X | X | 6 |
| 4 | X | X | | X | X | X | 5 |
| 5 | X | X | X | X | X | | 5 |
| 6 | X | X | | X | X | X | 5 |
| 7 | X | X | | X | X | | 4 |
| 8 | X | X | | X | X | | 4 |
| 9 (C) | X | | X | | | X | 3 |
| 10 (C) | X | X | | X | | X | 4 |
| 11 (C) | X | X | | | | | 2 |
| 12 (C) | X | X | | X | | | 3 |
| 13 (C) | X | X | | X | | | 3 |
| 14 (C) | X | X | | | | | 2 |
| 15 (C) | X | X | | X | | | 3 |
| 16 (C) | X | X | | | | | 2 |

As can be seen from the results above, the composition of Example 3 is particularly suitable for use in the production of moulds. However, a number of the other compositions according to the present invention also produced good moulds.

Moulds with a particularly good surface were produced by using a vacuum when adding the filler to the polyol and also by inclusion of an anti-foaming agent. The benefit of a good mould surface is that the resultant article produced from the mould has similar excellent surface properties.

A filled polyurethane mould according to the present invention can be produced for significantly less cost than the corresponding mould made solely from aluminium.

1. A composition comprising a polyurethane and from 20 to 80 weight percent of a particulate metal or metal alloy filler, wherein polyurethane is the reaction product of:
a) a first polyol, the first polyol having a molecular weight of less than 1000;
b) a second polyol, the second polyol having a molecular weight of from 1500 to 10000; and
c) at least one polyisocyanate, and
wherein the particulate metal or metal alloy filler has a thermal conductivity of at least 150 watts/m·° K.

2. A composition as claimed in claim 1 having a density of at least 1.2 g/cm³.

3. A composition as claimed in claim 1, wherein the first and second polyols are polyether polyols.

4. A composition as claimed in of claim 1, wherein the metal or metal alloy is at least one of aluminium, copper, silver, gold, bronze and zinc.

5. A composition as claimed in claim 1 wherein the composition additionally comprises a water absorbent.

6. A composition as claimed in claim 1 wherein the composition additionally comprises an anti-foaming agent.

7. A composition comprising a polyurethane, a zeolite paste and a particulate metal or metal alloy filler, wherein the polyurethane is the reaction product of:
a) from 40 to 60 parts by weight of a first polyether polyol, the first polyether polyol having a molecular weight of from 100 to 600 and a functionality of from 2 to 8;
b) from 40 to 60 parts by weight of a second polyether polyol, the second polyether polyol having a molecular weight of from 1500 to 8000 and a functionality of from 2 to 6; and
c) at least one isocyanate, wherein the isocyanate is present in an amount to provide for an isocyanate index of from 80 to 115, and wherein the composition comprises
from 5 to 15 parts by weight of the zeolite paste and from 50 to 200 parts by weight of a particulate aluminium filler.

8. A mould comprising the composition of claim 1.

9. A mould as claimed in claim 8, wherein the mould is for forming a plastics material part.

10. A mould as claimed in claim 8, wherein the mould is for forming part of a footwear article.

11. A mould as claimed in claim 10, wherein the mould is for forming a sole for a footwear article.

12. A mould for producing a plastics material part comprising a polyurethane and a particulate metal or metal alloy filler, wherein the polyurethane is the reaction product of:
a) a first polyol, the first polyol having a molecular weight of less than 1000;
b) a second polyol, the second polyol having a molecular weight of from 1500 to 10000; and
c) at least one polyisocyanate.

13. (canceled)

14. A method of producing a mould, comprising the steps of:
i) mixing a first polyol having a molecular weight of less than 1000 and a second polyol having a molecular weight of from 1500 to 10000;
ii) adding a particulate metal or metal alloy filler to the mixture of step i) wherein the metal has a thermal conductivity of at least 150 watts/m·° K;
iii) mixing the polyol and filler mixture under vacuum; and
iv) adding at least one isocyanate and mixing.

15. A mould comprising the composition of claim 7.
